(19) United States
(12) Patent Application Publication
(10) Pub. No.: US 2013/0222082 A1
(43) Pub. Date: Aug. 29, 2013

(54) EQUALIZER FOR MULTI-LEVEL EQUALIZATION

(71) Applicants: PO-CHUAN HSIEH, Tu-Cheng (TW); YING-TSO LAI, Tu-Cheng (TW); CHENG-HSIEN LEE, Tu-Cheng (TW)

(72) Inventors: PO-CHUAN HSIEH, Tu-Cheng (TW); YING-TSO LAI, Tu-Cheng (TW); CHENG-HSIEN LEE, Tu-Cheng (TW)

(73) Assignee: HON HAI PRECISION INDUSTRY CO., LTD., Tu-Cheng (TW)

(21) Appl. No.: 13/564,768

(22) Filed: Aug. 2, 2012

(30) Foreign Application Priority Data
Feb. 24, 2012 (TW) 101106435

(51) Int. Cl. H04B 3/14

(52) U.S. Cl. 333/28 R

(57) ABSTRACT

An equalizer includes a first delay module, a second delay module, a first amplitude module, a second amplitude module, and a combining unit. The first delay module receives a first signal and delays the first received signal for a preset period, and the first amplitude module transfers the first delayed signal to transmit a first weighted signal with a first peak amplitude. Similarly, the second delay module receives the first delayed signal and delays the second received signal for the preset period, and the second amplitude module transfers the second delayed signal to transmit a second weighted signal with a second peak amplitude. The combining unit combines an input signal and the first and the second weighted signals together to generate an equalized signal.

### BACKGROUND

1. Technical Field

The present disclosure relates to an equalizer, and particularly to an equalizer for a multi-level equalization.

2. Description of Related Art

Attenuation is unavoidable during transmission of high frequency signals, such as digital signals, so an error rate of those signals will be gradually increased. Therefore, a waveform equalizer is used to perform high frequency compensation for the high frequency signals before the signals are transmitted. However, conventional waveform equalizers can perform only one-level frequency compensation, but cannot perform multi-level frequency compensation according to actual requirements. Thus, effect of the conventional waveform equalizers is limited for the high frequency signals.

Therefore, there is need for improvement in the art.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of an embodiment of an equalizer of the present disclosure.

FIG. 2 is a waveform diagram of an input signal, unit signals, weighted signals, and an equalized signal of the equalizer in FIG. 1.

### DETAILED DESCRIPTION

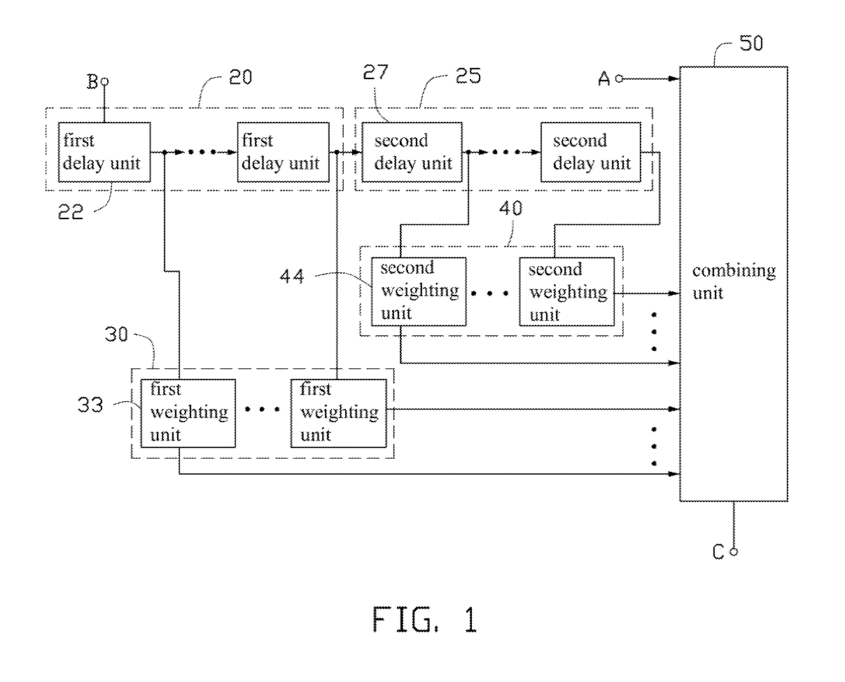

FIG. 1 is an embodiment of an equalizer of the present disclosure. The equalizer includes a first delay module 20, a second delay module 25, a first amplitude module 30, a second amplitude module 40, and a combining unit 50. In addition, the equalizers further includes a first input terminal A for receiving an input signal to be equalized, a second input terminal B for receiving a first signal, and an output terminal C for transmitting an equalized signal. In the embodiment, the first signal is a unit signal.

The first input terminal A is connected to the combining unit 50. The second input terminal B is connected to the first delay module 20. The first delay module 20 is connected to the second delay module 25 and to the combining unit 50 through the first amplitude module 30. The second delay module 25 is connected to the combining unit 50 through the second amplitude module 40. The combining unit 50 is connected to the output terminal C. The input signal is transmitted into the combining unit 50 through the first input terminal A, and the first signal is transmitted into the first delay module 20 through the second input terminal B.

The first delay module 20 includes a plurality of first delay units 22. The first delay units 22 of the first delay module 20 are connected in series. The first signal received from the second input terminal B is transmitted consecutively from a first one of the first delay units 22 to a last one of the first delay units 22. For example, the first one of the first delay units 22 transmits the signal to the second one of the first delay units 22, and then the second one of the first delay units 22 transmits the signal to the third one of the first delay units 22.

During the transmission procedure, each of the first delay units 22 receives the first transmitted signal from a previous one, delays the received signal for a unit period, and then transmits the delayed signal. In other words, the first one of the first delay units 22 receives the first signal. The first received signal of the first one is delayed and the first delayed signal of the first one is transmitted to the second one of the first delay units 22. Then, the second one of the first delay units 22 receives the first transmitted signal from the first one of the first delay units 22. The first received signal of the second one is delayed the first delayed signal of the second one is transmitted, and the rest may be deduced by analogy.

The second delay module 25 includes a plurality of second delay units 27. The second delay units 27 of the second delay module 25 are connected in series. A second signal received from the first delay module 20 is transmitted consecutively from a first one of the second delay units 27 to a last one of the second delay units 27, wherein the first delay module 20 delays the first signal to form the second signal through each of the first delay units 22. Similarly, during the transmission procedure, each of the second delay units 27 receives the second transmitted signal from a previous one, delays the second received signal for the unit period, and then transmits the second delayed signal.

The first amplitude module 30 includes a plurality of first weighting units 33. Each of the first weighting units 33 is connected to a corresponding one of the first delay units 22, so the number of the first weighting units 33 is equal to the number of the first delay units 22. Each of the first weighting units 33 connects the corresponding first delay unit 22 to the combining unit 50, receives the first delayed signal, and transmits a first weighted signal with a first peak amplitude A1. For example, a first one of the first weighting units 33 receives a first one of the first delayed signals from the first one of the first delay units 22, and transmits a first one of the first weighted signals with the first peak amplitude A1. A second one of the first weighting units 33 receives a second one of the first delayed signals from the second one of the first delay units 22, and transmits a second one of the first weighted signals with the first peak amplitude A1.

The second amplitude module 40 includes a plurality of second weighting units 44. Each of the second weighting units 44 is connected to a corresponding one of the second delay units 27, so the number of the second weighting units 44 is equal to the number of the second delay units 27. Similarly, each of the second weighting units 44 connects the corresponding second delay unit 27 to the combining unit 50, receives the second delayed signal, and transmits a second weighted signal with a second peak amplitude A2.

The first weighting units 33 have a first weighted coefficient, and the second weighting units 44 have a second weighted coefficient. The first peak amplitude A1 is computed according to the first weighted coefficient, and the second peak amplitude A2 is computed according to the second weighted coefficient. The first weighted coefficient is different from the second weighted coefficient. In the embodiment, the first weighted coefficient is larger than the second weighted coefficient.

The combining unit 50 is utilized to combine the input signal from the first input terminal A, the first weighted signals from the first weighting units 33 and the second weighted signals from the second weighting units 44 together to generate an equalized signal. The equalized signal is transmitted through the output terminal C.

An operating principle of an embodiment of the present disclosure is described as follows.

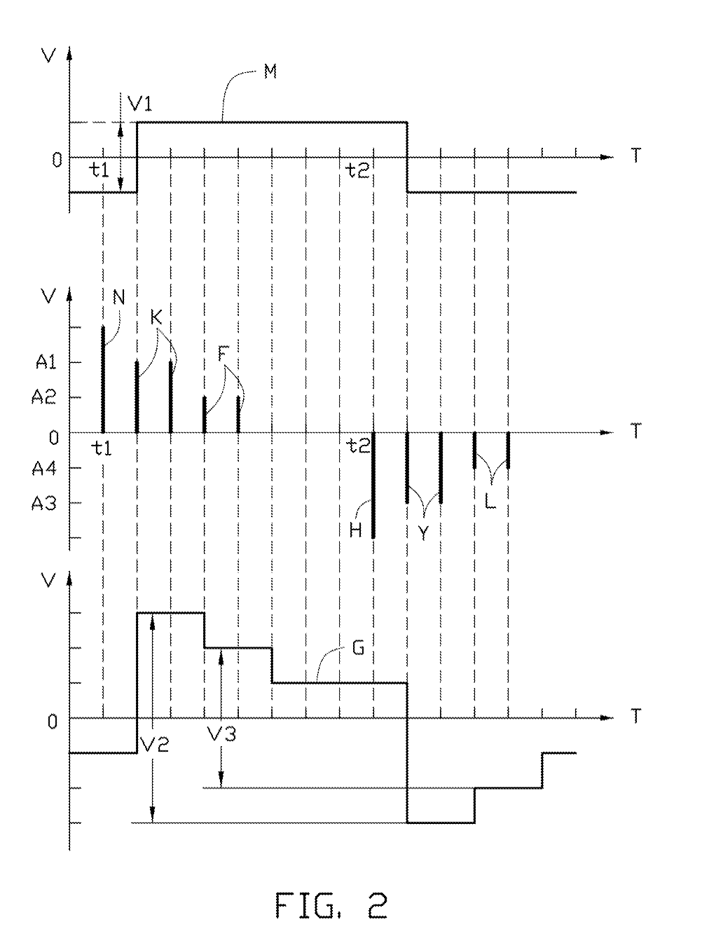

As shown in FIG. 2, the input signal (whose waveform is an input waveform M) is received by the combining unit 50 through the first input terminal A. The first signal (whose waveform is a first unit waveform N) is transmitted to the first delay module 20 through the second input terminal B at a first time t1. Each of the first delay units 22 delays their respective first received signals for the unit period and transmits their respective first delayed signals to the corresponding first weighting unit 33. Each of the first weighting units 33 transfers their respective first delayed signals with the first weighted coefficient to transmit the first weighted signal (whose waveform is a first weighted waveform K) with the first peak amplitude A1 to the combining unit 50. Similarly, each of the second delay units 27 delays their respective second received signals for the unit period and transmits their respective second delayed signals to the corresponding second weighting unit 44. Each of the second weighting units 44 transfers their respective second delayed signals with the second weighted coefficient to transmit the second weighted signal (whose waveform is a second weighted waveform F) with the second peak amplitude A2 to the combining unit 50.

Besides, a third signal (whose waveform is a second unit waveform H) is transmitted to the first delay module 20 through the second input terminal B at a second time t2 and delayed by each of the first delay units 22 to form a fourth signal. In the embodiment, the third signal is a unit signal. Similarly, each of the first delay units 22 transmits their respective third delayed signals according to the third signal, the second delay module 25 receives the fourth signal, and each of the second delay units 27 transmits their respective fourth delayed signals according to the fourth signal. Moreover, each of the first weighting units 33 receives a corresponding third delayed signal and transfers the corresponding third delayed signal with the first weighted coefficient to transmit a third weighted signal (whose waveform is a third weighted waveform Y) with a third peak amplitude A3 to the combining unit 50. Similarly, each of the second weighting units 44 receives a corresponding fourth delayed signal and transfers the corresponding fourth delayed signal with the second weighted coefficient to transmit a fourth weighted signal (whose waveform is a fourth weighted waveform L) with a fourth peak amplitude A4 to the combining unit 50.

The combining unit 50 combines the input signal from the first input terminal A, the first weighted signals and the third weighted signals from the first weighting units 33, and the second weighted signals and the fourth weighted signals from the second weighting units 44 together to generate the equalized signal (whose waveform is a equalized waveform G).

The first signal is different from the third signal. In the embodiment, an absolute value of a peak amplitude of the first signal is the same as that of the third signal, but a direction of the first signal is different from that of the third signal. In other embodiments, the absolute value of the peak amplitude of the first signal can be different from that of the third signal.

In the embodiment, a time interval between the first time t1 and the second time t2 is larger than a total delay time. In other words, the time interval is larger than a sum of the delay times delayed by the first delay units 22 and the second delay units 27, wherein the sum can be computed according to a first equation (X+Z)×T. X is the number of the first delay units 22, Z is the number of the second delay units 27, and T is the unit period. In the embodiment, X and Z are a positive integer and both of them are more than 1.

After comparing the equalized signal with the input signal, it can be found that the equalized signal has a first equalization gain S1 and a second equalization gain S2. The first equalization gain S1 is computed by a second equation

$$S 1 = 20 \times log [ \frac{V 2 - V 1}{V 2} ] .$$

The second equalization gain S2 is computed by a third equation

$$S 2 = 20 \times log [ \frac{V 3 - V 1}{V 3} ] ,$$

wherein V1 is an amplitude of the input signal, V2 is an amplitude between a maximum voltage and a minimum voltage of the equalized signal, and V3 is an amplitude between a second largest voltage and a second smallest voltage of the equalized signal.

The above equalizer delays the signal for a period via the first and the second delay modules 20 and 25. Then, the equalizer transfers the delayed signals to transmit the weighted signals with two peak amplitudes by the first and the second amplitude modules 30 and 40, and combines the input signal and the weighted signals by the combining unit 50 to generate the equalized signal. Hereby, the equalizer can effectively compensate high frequency attenuation of the high frequency signals, such as digital signals, during signal transmission.

In the embodiment, the equalizer includes two delay modules and two amplitude modules to obtain the equalized signal with two-level equalization gain. This is just a simple embodiment for convenience of the description. In other embodiments, the number of the delay modules in the equalizer can be more than 2 so the number of the amplitude modules corresponding to the delay modules can also be more than 2. Therefore, the signal can be transmitted in more than two delay modules and be transferred to generate the weighted signals with more than two peak amplitudes. Accordingly, the equalizer can perform multi-level equalization to generate an equalized signal with multi-level equalization grain.

While the disclosure has been described by way of example and in terms of various embodiments, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. An equalizer for a multi-level equalization, comprising:
a first delay module comprising a plurality of first delay units connected in series, and configured to receive a first signal at a first time and to transmit the first signal from a first one of the first delay units to a last one of the first delay units consecutively, wherein each of the first delay units receives the first transmitted signal, delays the first received signal for a unit period, and transmits the first delayed signal to a next one of the first delay units;
a second delay module comprising a plurality of second delay units connected in series, and configured to receive a second signal from the first delay module and to transmit the second signal from a first one of the second delay units to a last one of the second delay units consecutively, wherein each of the first delay units delays the first signal to form the second signal, and each of the second delay units receives the second transmitted signal, delays the second received signal for the unit period, and transmits the second delayed signal to a next one of the second delay units;
a first amplitude module comprising a plurality of first weighting units, wherein each of the first weighting units is connected to a corresponding one of the first delay units, and receives the corresponding first delayed signal to transmit a first weighted signal with a first peak amplitude;
a second amplitude module comprising a plurality of second weighting units, wherein each of the second weighting units is connected to a corresponding one of the second delay units, and receives the corresponding second delayed signal to transmit a second weighted signal with a second peak amplitude; and
a combining unit configured to combine an input signal, the first weighted signals from each of the first weighting units, and the second weighted signals from each of the second weighting units together to generate an equalized signal.

2. The equalizer of claim 1, wherein the first delay module receives a third signal at a second time, each of the first delay units transmits a third delayed signal according to the third signal, each of the first delay units delays the third signal to form a fourth signal, the second delay module receives the fourth signal, each of the second delay units transmits a fourth delayed signal according to the fourth signal, each of the first weighting units receives a corresponding one of the third delayed signals to transmit a third weighted signal with a third peak amplitude, each of the second weighting units receives a corresponding one of the fourth delayed signals to transmit a fourth weighted signal with a fourth peak amplitude, and the combining unit combines the input signal, the first weighted signals and the third weighted signals from each of the first weighting units, and the second weighted signals and the fourth weighted signals from each of the second weighting units together to generate the equalized signal.

3. The equalizer of claim 2, wherein the first signal is different from the third signal.

4. The equalizer of claim 2, wherein a time interval between the first time and the second time is larger than a total delay time computed by a first equation, the first equation is (X+Z)×T, X is number of the first delay units, Z is number of the second delay units, and T is the unit period.

5. The equalizer of claim 2, wherein the first peak amplitude and the third peak amplitude are computed according to a first weighted coefficient, the second peak amplitude and the fourth peak amplitude are computed according to a second weighted coefficient, and the first weighted coefficient is different from the second weighted coefficient.

6. The equalizer of claim 2, wherein the equalized signal has a first equalization gain computed by a second equation, the second equation is 20×log [(V2−V1)V2], V1 is an amplitude of the input signal, and V2 is an amplitude between a maximum voltage and a minimum voltage of the equalized signal.

7. The equalizer of claim 2, wherein the equalized signal has a second equalization gain computed by a third equation, the third equation is 20×log [(V3−V1)/V3], V1 is an amplitude of the input signal, and V3 is an amplitude between a second largest voltage and a second smallest voltage of the equalized signal.

8. The equalizer of claim 1, wherein number of the first weighting units is equal to number of the first delay units, and number of the second weighting units is equal to number of the second delay units.

9. The equalizer of claim 1, further comprising:
a first input terminal configured to receive the input signal and to transmit the input signal to the combining unit;
a second input terminal configured to receive the first signal and to transmit the first signal to the first delay module; and
an output terminal configured to transmit the equalized signal.
